(19) United States
(12) Patent Application Publication
(10) Pub. No.: US 2010/0298195 A1
(43) Pub. Date: Nov. 25, 2010

(54) Composition

(75) Inventors: Giorgio Franzolin, Mirano (IT); Zefferino Righetto, Ladenburg (DE); Dora Zamuner, Mira (IT); Silvia Baldan, Mira (IT); Dario Pisignano, Lecce (IT); Luana Persano, Lecce (IT); Elisabetta Marulli, Lecce (IT)

Correspondence Address: PARFOMAK, ANDREW N.;NORRIS MCLAUGHLIN & MARCUS PA, 875 THIRD AVE, 8TH FLOOR, NEW YORK, NY, 10022, US

(73) Assignee: Reckitt Benckiser N.V., Hoofddorp (NL)

(21) Appl. No.: 12/597,348

(22) PCT Filed: Apr. 25, 2008
(86) PCT No.: PCT/GB08/01458

§ 371 Date: Mar. 12, 2010

(30) Foreign Application Priority Data
Apr. 25, 2007 (GB) 0707972.6
Aug. 11, 2007 (GB) 0715705.0
Sep. 10, 2007 (GB) 0717601.9

(51) Int. Cl. C11D 3/395; C11D 3/60; B01J 31/04; B01J 31/06; C11D 17/00; B01J 29/06

(52) U.S. Cl. 510/298; 510/311; 502/159; 502/5; 502/62

(57) ABSTRACT

A composition comprises a bleaching catalyst admixed with an insoluble support matrix.

The present invention relates to a composition comprising a bleaching catalyst admixed with a support matrix.

Inorganic peroxygen compounds, especially hydrogen peroxide and solid peroxygen compounds which dissolve in water to release hydrogen peroxide, such as sodium perborate and sodium carbonate perhydrate, have long been used as oxidizing agents for purposes of disinfection and bleaching. The oxidizing action of these substances in dilute solutions is heavily dependent on the temperature; for instance, with H₂O₂ or perborate in alkaline bleaching liquors, sufficiently rapid bleaching of soiled textiles is obtained only at temperatures above about 80° C. At lower temperatures the oxidizing action of the inorganic peroxygen compounds can be enhanced by adding what are called bleach activators, for which numerous proposals have been disclosed in the literature, principally from the classes of the N-acyl or O-acyl compounds, examples being polyacylated alkylenediamines, especially tetraacetylethylenediamine, acylated glycolurils, especially tetraacetylglycoluril, N-acylated hydantoins, hydrazides, triazoles, hydrotriazines, urazoles, diketopiperazines, sulfurylamides and cyanurates, and also carboxylic anhydrides, especially phthalic anhydride, carboxylic esters, especially sodium nonanoyloxybenzenesulfonate, sodium isononanoyloxybenzenesulfonate and acylated sugar derivatives, such as pentaacetylglucose. By addition of these substances the bleaching action of aqueous peroxide liquors can be increased to such an extent that even at temperatures around 60° C. essentially the same activities occur as with the peroxide liquor alone at 95° C.

Given the concern for energy-saving laundering and bleaching methods, in recent years application temperatures well below 60° C. have gained in importance, in particular below 45° C. down to the cold water temperature, below 20° C.

Previously the use of transition metal salts and transition metal complexes has been described, for example in European patent applications EP 392 592, EP 443 651, EP 458 397, EP 544 490, EP 549 271 and WO 01/48138, referred to as bleaching catalysts.

It has now been observed that textiles, particularly coloured textiles, fade after a number of washes in the presence of a bleach catalyst. It is theorised that some catalysts previously used not only catalyze the activity of the peroxygen compound but also remain at least partly on their surfaces being bleached, and even when the cleaning operation has ended. These transition metal salts can then be oxidized and so cause colour damage, and, in extreme cases, the risk of oxidative damage to the textiles since they directly contact the textile. As an example a deposit of Mn (II), is readily oxidized to Mn (IV) dioxide, which is a very strong oxidizing agent, particularly toward easily oxidizable substances, such as organic dye compounds.

All of the bleaching catalysts known have the disadvantage that they are brought into intimate contact with the surfaces of the articles being treated and as such typically a portion of the catalyst adheres to those surfaces or even penetrate those surfaces. This gives rise to a risk of unwanted colour changes and in rare cases, there may even be holes/tears, as a result of fibre damage.

According to a first aspect of the invention there is provided a composition comprising a bleaching catalyst admixed with an insoluble support matrix.

Preferably the matrix is insoluble in aqueous media.

It has been found that the supported bleach catalyst of the present invention has a number of advantageous properties. The principle advantageous property is that the bleach catalyst, particularly the transition metal thereof when present (when used in a washing/bleaching operation) is not substantive upon an item being washed or bleached. Thus detrimental damage to the item is drastically reduced.

Another advantage of the present invention (when used in a washing/bleaching operation) is the catalysis of the oxidizing action and bleaching action of inorganic peroxygen compound at low temperatures. Effective catalysis is observed below 80° C. and in particular from about 12° C. to 40° C.

Another advantage of the present invention (when used in a washing/bleaching operation) is to allow for reduction of peroxygen amount and/or bleach activator (e.g. TAED) in a cleaning formulation while maintaining bleaching performance, thus allowing for cost reduction.

Being reusable and recoverable, a further advantage of the present invention is the repeated application of the novel solid oxidation bleaching catalyst. Such repeated applications can be useful in waste water treatment/water purification, for example in the textile industry and in pulp/cellulose bleaching operations.

Preferably the bleach catalyst comprises a transition metal compound based upon one or more of manganese, copper, iron, silver, platinum, cobalt, nickel, titanium, zirconium, tungsten, molybdenum, ruthenium, cerium, lanthanum or vanadium. Most preferably the bleach catalyst comprises a transition metal compound based upon manganese.

The manganese bleach catalyst may be selected from wide range of manganese compounds. Suitable inorganic compounds (often salts) of manganese (e.g. Mn (II)) include hydrated/anhydrous halide (e.g. chloride/bromide), sulphate, sulphide, carbonate, nitrate, oxide. Further examples of suitable compounds (often salts) of manganese (e.g. Mn (II)) include hydrated/anhydrous acetate, lactate, acetyl acetonate, cyclohexanebutyrate, phthalocyanine, bis(ethylcyclopentadienyl), bis(pentamethylcyclopentadienyl).

Most preferably the bleach catalyst comprises manganese (II) acetate tetrahydrate and/or manganese (II) sulphate monohydrate.

Alternatively the bleach catalyst may comprise:—

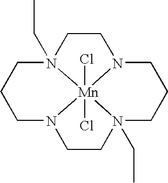

### (1,8-diethyl-1,4,8,11-TetraAzaCycloTetraDecane)manganese (II) chloride [Mn-TACTD]

Alternatively the bleach catalyst may comprise:—

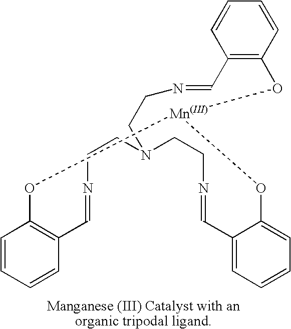

Alternatively the bleach catalyst may comprise:—

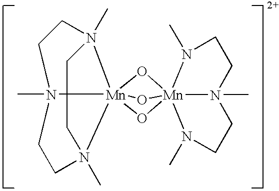

Generally the bleach catalyst comprises from 0.001% to 10.00%, preferably from 0.01% to 5.00% more preferably from 0.15% to 2.5% of the composition, with the remainder of the composition comprising the support matrix.

Generally the composition is for use in a washing operation, e.g. a textile washing operation in an automatic washing machine. The composition may be used for multiple washing operations; in this case the composition may comprise a shaped article.

Preferably the shaped article is an article which is commonly used in a washing operation but which has been modified to comprise the composition of invention. One particularly preferred such article is a “dosing ball”, which are commonly used, particularly in laundry washing operations, for the dosing of the correct amount of detergent into the washing cycle. Such dosing balls are by their nature reusable and thus the dosing ball is able to provide a bleach catalyst function over a plurality of wash cycles. The whole/a portion of the dosing may comprise the composition.

Another preferred article is a bucket/container which is used in combination with a bleach based formulation in a cleaning operation, e.g. for hard surface cleaning (floor cleaning or glass/window cleaning) or for a manual laundry operation. The bucket/container are preferably made by injection moulding of plastic (PP, PE, ABS, PMMA, polyamide, PVC, PU or any other plastic material).

A yet further article is a plastic table surface such as the kind used for manual laundry cleaning (in some developing countries).

Another article is a brush used in combination with a bleach based formulation in a cleaning operation, e.g. for rubbing clothes/laundry, dish/house ware or for toilet/ceramic cleaning.

Further articles include roll balls for pre-treating laundry, cleaning cloths, internal plastic components of automatic laundry washing machines and dishwashing machine/, reusable plastic food containers/cutlery.

Alternatively the shaped article may comprise a powder, a particle, a flake, a sheet or a fibre (e.g. a micro-fibre/nano-fibre) or a sponge.

The shaped article may be in the form of a foam.

These micro-structures may be agglomerated together into a macro-structure, e.g. the particles may be partially coalesced to make a honeycomb type structure or the fibres may be coalesced to make a woven/non-woven mat macro-structure.

Where the support is a particle, the preferred particle size is in the range of from 10 nm to 10 mm, more preferably from 0.1 mm to 10 mm, most preferably from 0.3 mm to 0.5 mm. The particles are preferably spherical.

Where the support is fibre, the preferred diameter in the range of from 30 nm to 2000 μm, more preferably from 60 nm to 1000 μm.

The support matrix generally comprises a polymeric material. Suitable polymeric materials may be selected from the group of polyurethanes; polyolefins/hydrocarbons, e.g. polypropylene, polyethylene, polystyrene, polybutadiene; polyamides; polyvinyl chloride; polyesters, e.g. poly methyl methacrylate, poly vinyl acetate; phenolic resins; copolymers, e.g. polymethylmethacrylate with n-butylacrylate and styrene; natural/modified natural polymers, e.g. cellulose, rubber, latex, styrene-butadiene rubber, butyl rubber, chlorinated/hydrochlorinated rubber, nitrile rubber, vulcanized rubber, siliconised rubber; polycarbonates; silicone resins; fluorinated resins, e.g. PTFE.

The support matrix may comprise an inorganic material. Suitable inorganic materials include zeolite, silica, alumina, zirconia, phosphates (e.g. AlPO₄), ceramic, glass, bauxite, anatase (TiO₂) and carbon.

According to a second aspect of the invention there is provided a method of producing a composition comprising a bleaching catalyst admixed with an insoluble support matrix.

Preferably the method comprises one or more techniques selected from the group of spinning, electro-spinning, solvent casting, thermal treatment, extrusion, co-extrusion, moulding, screw injection moulding, injection moulding, blow moulding, machine moulding, thermal press moulding, free moulding, compression moulding, transfer moulding, roto-moulding, jet moulding, steam chest moulding, sheet moulding, sheet moulding compound SMC, laminated moulding, cast moulding, moulding powder, moulding pressure, forming, vacuum forming, plug-assist vacuum forming, hot forming, free-blow forming, high-rate forming, magnetic forming, rubber forming, drape forming, plug-and-ring forming, hot powder forming, snapback forming, matched-die forming, cavity forming, cavity assist-forming, shock-forming, electrochemical forming, electro forming, pressing, cold forging and/or polymerisation.

Preferably thermal treatment (or thermoforming) involves heating the support material (e.g. a polymer such as PMMA) above its melting temperature and/or above its Tg (glass transition temperature), admixing the bleach catalyst therewith and allowing the admixture to cool.

Preferably casting involves dissolution of both the support and the oxidation catalyst in a solvent followed by deposition of the solution onto a surface (e.g. stainless steel or semiconductor material) and evaporation of the solvent with production of a free-standing solid support. Suitable solvents include: chlorinated organic solvents (e.g. chloroform), ketones (e.g. acetone or methyl ethyl ketone), dimethylsulfoxide (DMSO), alcohols, aliphatic or aromatic hydrocarbons, glycol ethers or organic acids, (e.g. acetic acid or formic acid).

Preferably extrusion and co-extrusion involves passing a composition comprising the support and the catalyst through an extrusion machine or a press machine. The extrusion is preferably performed at an elevated temperature which may be affected by heating or by the pressure applied by the extruder.

The extrusion conditions depend to a degree upon the exact nature of the composition being extruded and by the type of machine used. A suitable extrusion operating temperature is, for example, 90-260° C. A suitable extrusion operating screw velocity is, for example, 25-250 rpm (rotation per minute), preferably 50-125 rpm. A suitable extrusion operating pressure is, for example, 30-250 bar. The extrudate is preferably in the form of pellets or strands or noodles.

Preferably electro spinning involves dissolution of both the support and the oxidation catalyst in a solvent followed by discharge of the solvent admixture through an orifice into a chamber where evaporation of the solvent occurs. Electric charging of the admixture occurs on or before discharge from the orifice. The charging of the admixture causes the admixture to distribute itself widely and sparsely leading to the production of fine fibres.

Preferably polymerisation involves formation of a polymeric support, by polymerisation of the polymer constituents in the presence of the oxidation catalyst to form a polymer matrix having the oxidation catalyst distributed there-through. The polymer matrix may be porous and/or be in the form a sponge. Preferred polymers suitable for use in this method include polymers formed in a condensation reaction such as polyesters and polyurethanes. Indeed polyurethanes are particularly suitable since foams and sponges may be readily made from such polymers.

Preferably the supported bleach catalyst is for incorporation in a detergent composition, e.g. a dishwashing, laundry, hard surface cleaning and/or disinfecting composition. Generally the composition is for use in the appropriate washing operation in a washing machine or other washing vessel such as a sink, bucket, etc. Alternatively the composition may be used in an additive (e.g. additives which are complementary to a detergent product used in a washing operation) or in addition to a product which contains a bleach.

The detergent composition may comprise a homogenous product, e.g. a uniform powder/liquid or alternatively the detergent composition may have a plurality of individual phases, e.g. such as a multi-phase tablet or a number of liquids contained in a multi-chamber container/bottle. Where a plurality of individual phases is present the supported bleach catalyst may be present in only a limited number of the phases, e.g. for a two phase tablet one phase may contain the supported bleach catalyst and one phase could be bleach catalyst free (and may contain a bleach, such as a source of peroxide/active oxygen).

The detergent composition typically comprises at least one of surfactant (anionic, non-ionic, cationic or amphoteric), builder, bleach, bleach activator, bleach stabilizer, bleaching catalyst, enzyme, polymer, co-builder, alkalizing agent, acidifying agent, anti-redeposition agent, silver protectant, colourant, optical brightener, UV stabilizer, fabric softener, fragrance, soil repellent, anticrease substance, antibacterial substance, colour protectant, discolouration inhibitor, vitamin, phyllosilicate, odor-complexing substance, rinse aid, foam inhibitor, foaming agent, preservative, or auxiliary.

The invention is now illustrated by reference to the following non-limiting examples.

### EXAMPLES

### Example 1

### Catalyst Preparation

2 g of Poly Methyl Methacrylate (PMMA) (Aldrich, average Mw 120,000) was weighed in a glass beaker. 3 mg of catalyst Mn-TACTD was added and mixed. The powder mixture was poured into a container made of a cylindrical steel holder (diameter 2.5 cm). The cylindrical holder was heated above 200° C. for 60 minutes and left to cool down at room temperature for 2 hours.

### Example 2

### Oxidation Catalysis Study

The following reagents were prepared, in deionised water.

| Reagent | g/L | ppm |
|---|---|---|
| Sodium Percarbonate (2Na₂CO₃•3H₂O₂) | 1.38 | 395 H₂O₂ |
| TAED | 0.30 | 300 |
| Mn-TACTD (homogeneous) | 0.008 | 8 |
| Cat (Example 1) | * | 8 |
| Saffron | 0.35 | 35 |

* catalysts at 0.15% concentration, particle size 0.2 mm.

A solution containing sodium percarbonate and bleach TAED was compared vs. a solution containing PCB, TAED and the catalyst Mn-TACTD (homogeneous) or vs. a solution containing PCB+TAED+the catalyst Mn-TACTD (heterogeneous).

### Protocol Used: Beaker Test

Saffron solution (fresh, protected from light)
Deionised water

### Temperature: 20° C.

Reaction studied over 30 minutes.
UV/VIS Abs at 430 nm to monitor the oxidation rate on substrate (saffron).
Note: the lower the absorbance residue, the better the catalytic effect/performance.

### Results

| | | HOMOGENEOUS | HETEROGENEOUS |
|---|---|---|---|
| | | CATALYSES | CAT |
| | PCB + | PCB + TAED + | PCB + TAED + |
| Time (minutes) | TAED | CAT | CAT (powder) |
| 0 | 100 | 100 | 100 |
| 5 | 94 | 86 | 91 |
| 15 | 78 | 60 | 59 |
| 30 | 61 | 38 | 42 |

(Each value is the average of three measurements.

The results show that the use of Mn-TACTD is effective as oxidation catalyst (vs. no catalyst) and that heterogeneous catalysis is at least as good as the use of homogenous catalysis on the bleaching of saffron.

### Example 3

### Analysis Washing liquor

The concentration of manganese in the wash liquor was measured. The solutions tested were those utilised in Example 2. The concentration of manganese was determined by Inductively Coupled Plasma-Atomic Emission Spectroscopy (ICP-AES).

The results are as follows.

| | Concentration | |
|---|---|---|
| Solution | Manganese | |
| Saffron + PCB/TAED | 6.5 × 10⁻³ | ppm* |
| Saffron + PCB/TAED + Mn-TACTD | 1.0 | ppm |
| (homogeneous) | | |
| Saffron + PCB/TAED + PMMA − | 10.5 × 10⁻³ | ppm** |
| Mn-TACTD (heterogeneous) | | |

*/** = few ppb, which is negligible and could be present as impurities from PCB, TAED or saffron.

No significant release of manganese into wash solution from the catalyst of Example 1 reinforces the principle of heterogeneous catalysis. Further as there is no release of manganese into wash solution this eliminates/reduces the potential build-up effect of this metal onto fibres, and as a consequence, the potential deleterious effect on fabrics/colours.

### Example 4

### Performance on Stains Under Washing Conditions

The following reagents were prepared.

| Ref | Product | Dosage (g/wash) |
|---|---|---|
| 1 | Laundry detergent powder (PCB | 68 |
| | and TAED containing) | |
| 2 | As Ref 1 (+0.132% Mn-TACTD | 68 |
| | homogeneous) | |
| 3 | As Ref 1 (+0.132% Mn-TACTD | 68 |
| | heterogeneous in PMMA) | |

The washing conditions used tap water at 25° F. hardness, 30° C. washing under a deep cleaning program in a front-loading European washing machine, using 3.5 kg of new and clean cotton ballast, with four replications. Final drying in a tumble drier and ironing of technical swatches. Instrumental evaluation via spectrophotometer (Y value). The higher the Y value, the better is the stain removal performance.

| Standard Stains | 1 | 2 | 3 |
|---|---|---|---|
| CFT CS-15 blueberry juice | 72.2 | 75.4 | 73.5 |
| CFT CS-19 peach juice | 78.2 | 82.6 | 81.8 |
| Empa 164 grass | 63.8 | 66.5 | 66.1 |
| Empa 167 tea on cotton | 62.7 | 73.8 | 70.8 |
| Empa 168 tea on polyester/ | 62.8 | 74.5 | 70.8 |
| cotton | | | |
| WFK 10K coffee | 85.0 | 86.8 | 86.1 |
| WFK 10LI wine | 73.0 | 78.8 | 75.9 |
| WFK 10T ketchup | 82.9 | 89.7 | 88.0 |
| WFK 10SG spaghetti sauce | 79.7 | 90.0 | 88.4 |

The results show that the use of Mn-TACTD is effective as oxidation catalyst (vs. no catalyst) and that heterogeneous catalysis is at almost as good as the use of homogenous catalysis yet without any of the problems of bleach catalyst build-up.

### Example 5

### Catalyst Preparation

The following procedure was followed.

### Raw Materials for Fibre Production Via Electro-Spinning:

### i) PMMA (Aldrich Catalogue M.W. 120,000) 300 mg.

### ii) Metal Catalyst: Mn-TACTD, 15 mg.

iii) 13% Dimethyl Sulfoxide 87% Chloroform 87%.

The solution was prepared by dissolving PMMA and Mn-TACTD in the solvent.

### Apparatus Used for Electro-Spinning

High Voltage Power Supply with Pump.

### Test Conditions

### Temperature: 19-22° C.

### RH Relative Humidity: >50%

Distance needle tip—collector: 9-10 cm
Syringe internal volume: 1 ml
Velocity for injection: 0.07 ml/min
Applied Tension Voltage for acceleration: 16 kV

A SEM (Scanning Electron Microscopy) investigation for morphology characterization showed the fibres were well-defined with a homogenous distribution both in shape and dimension. The fibre diameter is summarized in the following table:

| Fibre Diameter | % |
|---|---|
| 0.6 μm-1.0 μm | 5 |
| 1.0 μm-1.5 μm | 9 |
| 1.5 μm-2.0 μm | 18 |
| 2.0 μm-2.5 μm | 31 |
| 2.5 μm-3.0 μm | 19 |
| 3.0 μm-3.5 μm | 13 |
| 3.5 μm-4.0 μm | 5 |

### Example 6

### Oxidation Catalysis Study

The comparison was done at parity concentration, using Mn-TACTD at 8 ppm in all cases.

A: SAFFRON+PCB+TAED (w/o catalyst).
B: SAFFRON+PCB+TAED+Mn-TACTD (homogeneous).
C: SAFFRON+PCB+TAED+Mn-TACTD fibre from Example 5.
D: SAFFRON+PCB+TAED+Mn-TACTD granules from Example 1.

| | |
|---|---|
| | % Absorbance |
| Time | residue at 430 nm |

| (minute) | A | B | C | D |
|---|---|---|---|---|
| 0 | 100 | 100 | 100 | 100 |
| 5 | 94 | 84 | 91 | 89 |
| 15 | 78 | 57 | 61 | 65 |
| 30 | 61 | 36 | 39 | 44 |

(Each value is the average of three measurements)

These data shows that the electro-spinning technique gives oxidation catalytic results almost in line with Mn-TACTD in homogeneous phase. It is postulated that electro-spinning give better results vs. the thermal treatment technique, due to the increased superficial area of the micro-fibre vs. the granules obtained via thermal treatment.

### Example 7

### Performance on Stains Under Washing Conditions

Using a laundry detergent compact (4.9 g/1), tap water at 25° F. hardness, room temperature 20° C., 30 washing in 2 litres of water in a bucket followed by rinsing. Final drying in the air and ironing of technical swatches. Instrumental evaluation via spectrophotometer (Y value).

The formulae tested were:

1: Laundry Detergent compact (PCB and TAED containing).
2: Laundry Detergent+Mn-TACTD (homogeneous).
3: Laundry Detergent+Mn-TACTD fibre from Example 5.

### Stain Removal Evaluation

| | | 1 | 2 | 3 |
|---|---|---|---|---|
| Standard Stains: | | | | |
| CFT BC-03 Tea | cot | 64 | 66 | 67 |
| CFT CS-19 Peach Juice | cot | 81 | 82 | 82 |
| Empa 167 Tea | cot | 66 | 72 | 71 |
| Empa 168 Tea | p/c | 68 | 75 | 71 |
| WFK 10K Coffee | cot | 85 | 86 | 86 |
| WFK 10LI Red wine | cot | 73 | 76 | 75 |
| WFK 10T Ketchup | cot | 84 | 88 | 85 |
| Fresh Stain: | | | | |
| SAFFRON* | cot | 71 | 74 | 73 |

(Each value is the average of four measurements)
*Saffron stain preparation: 2.8 g/litre saffron solution in water-Saffron brand: Bonetti.
Cotton swatches 6 cm × 6 cm soaked for 1 minute.
Dried in the dark, at ambient condition for 1 day prior to wash test.

### Example 8

### Catalyst Preparation

2 g PMMA (Aldrich, average Mw 120,000) was weighed in a glass beaker. 20 mg manganese acetate tetrahydrate (Kemira) was added and mixed. The powder mixture was poured into a container made of a cylindrical steel holder (diameter 2.5 cm). The cylindrical holder was heated above 200° C. for 60 minutes and left to cool down at room temperature for another 2 hours.

### Example 9

### Oxidation Catalysis Study

The catalytic efficiency of catalyst of Example 8 was tested in the same way as in example 2. The comparison was done at parity manganese acetate concentration (5 mg/L).

| | | HOMOGENEOUS | HETEROGENEOUS |
|---|---|---|---|
| | | CATALYSIS | CATALYSIS |
| Time | PCB + | PCB + TAED + | PCB + TAED + |
| (minutes) | TAED | Mn Acetate | Mn Acetate |
| 0 | 100 | 100 | 100 |
| 5 | 94 | 88 | 90 |
| 15 | 85 | 70 | 74 |
| 30 | 60 | 48 | 54 |

(Each value is the average of three measurements)

The results show that the use of manganese (II) acetate is effective as oxidation catalyst (vs. no catalyst) and that heterogeneous catalysis is as good as the use of homogenous catalysis on the bleaching of saffron.

### Example 10

### Pilot Plant Production of Solid Support PMMA+Metal Catalyst

### Manufacturing Procedure

The following extrudates were produced:

### Sample A

### Polymer: PMMA Altuglas VM 100 (Arkema)

### Catalyst: 2% Manganese (II) Acetate Tetra Hydrate (Kemira)

### Process Parameters:

Press Machine for plastic injection moulding; mono screw (screw diameter 32 mm, universal type). Machine not vented.

### Temperature Set Up 140° C.

Velocity Set Up at about 200 rpm (screw)
Pressure measured 45-50 bar.

The resulting solid catalyst was white, opaque, highly porous.

### Sample B

Polymer: PMMA ZK 30 (High Impact Plexiglas®, supplied by Degussa-Evonik)

### Catalyst: 2.2% Manganese (II) Acetate Tetra Hydrate (Kemira)

### Process Parameters:

Press Machine for plastic injection moulding; mono screw (screw diameter 32 mm, universal type). Machine not vented.

### Temperature Set Up 160° C.

Velocity Set Up at about 200 rpm (screw)
Pressure measured 45-50 bar.

The resulting wires were white, opaque, and highly porous.

### Sample C

### Polymer: PMMA VM 100 (Arkema)

Catalyst: 0.276% Manganese Sulphate Mono Hydrate (supplied by Aldrich-Sigma)

### Process Parameters:

Press Machine for plastic injection moulding; mono screw (screw diameter 32 mm, universal type). Machine not vented.

### Temperature Set Up 160° C.

Velocity Set Up at about 200 rpm (screw)
Pressure measured 45-50 bar.

The resulting solid catalyst was colourless, transparent, with limited porosity.

For Sample C to improve the manganese distribution inside PMMA, during pilot plant trial a pre-mix of manganese sulphate salt and PMMA was prepared. The very fine manganese sulphate particles stuck onto PMMA pellets by mechanical agitation of the two ingredients.

### Example 11

### Physical Characterisation of Extruded PMMA+Catalyst

Samples A, B and C were analyzed for porosity using a mercury porosimeter (Autopore III Micromeritics) and by Scanning Electron Microscopy (SEM—using a Philips XL30 apparatus). SEM investigation was conducted on extruded noodles both on the external surface and on internal side (longitudinal section).

Porosity is a critical parameter for catalysts entrapped/adsorbed onto a non-water soluble matrix to be used in a heterogeneous phase.

Porosity data are summarized in the table below:

| | A | B | C |
|---|---|---|---|
| Porosity | 49.5% | 59.2% | 20.8% |
| Pore Type | Internal + external | Internal + | Closed pores |
| | surface | external | only internal |
| | | surface | |
| Average | 500 micron | <100 micron | Few hundred |
| Pore | | | micron up to |
| Diameter | | | 1 mm |
| Bulk Density | 0.622 | 0.544 | 1.052 |
| (g/ml) | | | |
| Apparent | 1.237 | 1.352 | 1.328 |
| Density, | | | |
| (g/ml) | | | |
| SEM Notes | Presence of | Presence of | The external |
| | diffused porosity | numerous | surface of |
| | both on the | pores of | the analysed |
| | external and | oval shapes | samples does |
| | internal part | with ragged | not show |
| | of the extruded | edge. Pores | pores. Only |
| | material. | are present | few internal |
| | Pores have oval | on both external | pores with |
| | shape, are | and | irregular |
| | mainly closed | internal | shapes are |
| | and not inter- | part of the | visible in |
| | connected. | extruded materials. | the longitudinal |
| | | Pores are | section. |
| | | mainly | These internal |
| | | closed, only | pores are |
| | | partially | partially |
| | | interconnected. | interconnected. |

Reasons for different porosity type/level in sample C vs. samples A and B could be due to:—

a) chemical differences of the metal bleach catalyst: sulphate monohydrate vs. acetate tetrahydrate. It is postulated that the level of water performs a key role in porosity formation, as water evaporates in the plasticization chamber of the extruder/press machine (based on Thermo Gravimetric Analysis). As the press machine is not vented, all the evolved gas remains entrapped inside the plastic materials/resins creating porosity.
b) lower concentration of metal catalyst inserted in sample C, 0.276% manganese sulphate vs. 2% manganese acetate included in samples A and B.

### Example 12

### Screening Test in Beaker

Samples were tested for their catalytic activity using the screening test in a beaker (already described in Example 2).

The results are shown below (taken after 30 minutes).

Heterogeneous Catalysis

| | | Milled | No catalyst |
|---|---|---|---|
| | 1 cm wire | granule | PCB/TAED |
| Sample | pieces | (<2 mm) | alone |
| A | 58 | 56 | 65 |
| 0.25 g/l | | | |
| B | 53 | 52 | |
| 0.25 g/l | | | |
| C | 58 | 56 | |
| 1.23 g/l | | | |

[Each value represents the average of 3 measurements].

And also for sample C

| | | HOMOGENEOUS | HETEROGENEOUS |
|---|---|---|---|
| | | CATALYSIS | CATALYSIS |
| | | PCB + TAED + | PCB + TAED + |
| Time | PCB + | MnSO₄ | MnSO₄ |
| (minutes) | TAED | (0.0034 g/l) | (1.23 g/l) |
| 0 | 100 | 100 | 100 |
| 5 | 98 | 88 | 90 |
| 15 | 87 | 79 | 79 |
| 30 | 65 | 54 | 56 |

(Each value is the average of three measurements)

The catalytic properties are retained and exhibited when manganese salts are included in the polymeric matrix: manganese acetate and manganese sulphate co-extruded with PMMA deliver a catalytic effect on the bleaching of saffron.

The milled sample (average particle size between 250 micron and 2 mm) showed higher activity. It is postulated that this is due to the increased surface area of the milled sample.

### Example 13

### Multi-Usage Test

In consecutive tests, a milled sample of catalyst from example 10, sample A (tested at 0.25 g/litre), was subject to 3 consecutive usages, to assess if catalytic performance is delivered on the bleaching of saffron upon cumulative usages. The results are reported in the table below.

| | | | | Ref. (no |
|---|---|---|---|---|
| Time (min) | Usage 1 | Usage 2 | Usage 3 | catalyst) |
| 0 | 100 | 100 | 100 | 100 |
| 10 | 89 | 92 | 92 | 98 |
| 15 | 77 | 80 | 81 | 87 |
| 30 | 55 | 57 | 58 | 63 |

The results confirm catalytic activity on the bleaching of saffron after 3 consecutive usages.

### Example 14

### Manganese Release

To assess whether manganese is released from the supporting matrix during usage in washing environment, a test was conducted under stressed conditions.

Catalyst from example 10, sample A (0.25 g/litre), was added to a wash solution containing a compact laundry detergent from the market (dosed at 4.9 g/litre) and stirred for 30 minutes at 60° C. The test material was removed by filtration, the water collected and analysed.

The test material was then rinsed with 100 ml of cold tap water for 5 minutes, and the rinse water collected. Five consecutive wash and rinse cycles were performed; manganese concentration measured via Atomic Absorption (Perkin Elmer Analyst 300). Results are reported in the following table:

| | ppm Mn |
|---|---|
| 1^{st} wash | 0.067 |
| 1^{st} rinse | 0.087 |
| 2^{nd} wash | 0.034 |
| 2^{nd} rinse | 0.028 |
| 3^{rd} wash | 0.027 |
| 3^{rd} rinse | 0.027 |
| 4^{th} wash | 0.022 |
| 4^{th} rinse | 0.028 |
| 5^{th} wash | 0.054 |
| 5^{th} rinse | 0.067 |

The amount of manganese released in each wash from the catalyst from example 10 is insignificant/negligible.

### Example 15

### Stain Removal Test Results

A performance test was conducted under realistic washing conditions.

The washing test was conducted using standard soils, a compact laundry detergent taken from the market as the base detergent plus 5 g of catalyst from example 10, sample A, introduced in a cellulose non-woven sachet at a washing temperature of 30° C.

The washing conditions used tap water at 25° F. hardness, 30° C. washing under a deep cleaning program in a front-loading European washing machine, using 3.5 kg of new and clean cotton ballast, with four replications. Final drying in a tumble drier and ironing of technical swatches. Instrumental evaluation via spectrophotometer (Y value).

The stain removal results are summarized in the following table.

| | | Detergent | Plus |
|---|---|---|---|
| Standard Stains: | | Alone | Catalyst |
| CFT CS-19 Peach Juice | cot | 81.0 | 82.3 |
| Empa 167 Tea | cot | 66.0 | 72.1 |
| Empa 168 Tea | p/c | 67.5 | 74.5 |
| WFK 10K Coffee | cot | 80.8 | 81.3 |
| WFK 10LI Red wine | cot | 74.2 | 77.4 |
| WFK 10SG Spaghetti Sauce | cot | 77.8 | 78.1 |

(Each value is the average of four measurements)

The catalyst containing formulation delivers significantly better stain removal results on oxidisable stains tested (tea, blueberry and peach juices, red wine, coffee, spaghetti sauce). For most stains, the superiority is easily visible by eyes and thus the benefit is consumer relevant.

### Example 16

### Manganese Released in Washing Machine Test

Water from the main wash (from example 15) was collected from the washing machine to measure the level of manganese present in the wash solution via Atomic Absorption Spectroscopy (Perkin Elmer Analyst 300).

The results are reported in the following table:

| | |
|---|---|
| % Mn released from solid | 10% |
| catalyst | |

Data reported are the average of four measurements.

The amount of manganese found in the water collected from main wash is negligible compared to the total amount of manganese added to each wash.

### Example 17

### Screening for Deleterious Effect on Colours

The effect (ΔE) on coloured fabrics caused by the solid supported catalyst was compared to the damage caused by catalysis in homogenous phase and by the damage caused by a compact laundry detergent from the market.

The catalyst of Example 10, sample A, was milled in granules of 1-2 mm in diameter and 5 g was added into a cellulose non-woven sachet.

Ten cumulative washes at 60° C. temperature were conducted using 1 litre solution in a beaker test, adding a new/fresh sachet/prototype to each wash.

Tested products and dosages are listed here below:

Test 1: 4.9 g/litre of compact detergent.
Test 2: As test 1 plus 0.25 g/litre of catalyst of Example 10, sample A.
Test 3: As test 1 plus 0.005 g/litre of manganese acetate tetrahydrate in homogeneous phase.

Both tests 2 and 3 give an effect manganese concentration of 1.0 ppm.

Colours and fabrics were selected based on their sensitivity to manganese. Dark blue and black colours were used; blue silk, sulphur black, navy reactive and black reactive.

The results are summarized in the following tables:

| | New | | | |
|---|---|---|---|---|
| | Unwashed | Test | | |
| | fabrics | 1 | 2 | 3 |
| Blue Silk | 0.6 | 4.7 | 3.8 | 6.9 |
| UMIST 1 Sulphur Black | 0.9 | 39.3 | 37.5 | 39.0 |
| UMIST 4 Brown | 0.5 | 8.6 | 8.5 | 8.9 |
| UMIST 5 Blue | 0.7 | 7.3 | 8.1 | 9.5 |
| UMIST 20 Navy Reactive | 0.7 | 14.9 | 15.3 | 20.1 |
| UMIST 21 Black Reactive | 0.9 | 9.8 | 10.3 | 15.5 |
| UMIST 26 Violet Reactive | 1.0 | 7.3 | 6.9 | 7.4 |

The highest the number, the worse the deleterious/fading effect on colours.

Supported catalyst is in line with detergent alone. This suggests that the deleterious effect on colours is caused mainly by the detergent alone, and not by metal bleach catalyst in heterogeneous phase (sample A).

Visual evaluation was conducted by a panel of 8 panellists using a scale from 1-5, wherein a score of 1 correspond to the result achieved solely with detergent alone and a score of 5 corresponds to a high difference compared to detergent.

Results are summarized in the following tables:

| | 1 | 2 | 3 |
|---|---|---|---|
| Blue Silk | 1.0 | 1.4 | 3.5 |
| UMIST 1 Sulphur Black | 1.0 | 1.1 | 2.4 |
| UMIST 4 Brown | 1.0 | 1.1 | 1.5 |
| UMIST 5 Blue | 1.0 | 1.1 | 1.3 |
| UMIST 20 Navy Reactive | 1.0 | 2.0 | 4.1 |
| UMIST 21 Black Reactive | 1.0 | 2.0 | 4.0 |
| UMIST 26 Violet Reactive | 1.0 | 1.3 | 1.4 |

On the tested fabrics, the visual panel test showed the usage of catalyst from Example 10, sample A, does not cause significant colour fading vs. standard laundry detergent.

### Example 18

### Manganese Build Up on Fabrics

Silk, viscose and cotton fabrics from Example 17 were evaluated using fluorescence XR to assess the level of manganese deposited after 10 cumulative washes in a beaker under the testing protocol. Results are expressed as absolute weight manganese/area [Mn μg/9 cm²].

| | New | | | |
|---|---|---|---|---|
| | Untreated | 1 | 2 | 3 |
| White Silk | 0.11 | 0.20 | 0.23 | 9.31 |
| White Viscous | 0.12 | 0.07 | 0.14 | 0.62 |
| Blue Silk | 0.23 | 0.21 | 0.15 | 5.63 |
| UMIST 1 Sulphur Black | 0.49 | 0.29 | 0.16 | 1.65 |
| UMIST 20 Navy Reactive | 0.25 | 0.19 | 0.24 | 3.94 |
| UMIST 21 Black Reactive | 0.26 | 0.25 | 0.29 | 2.82 |
| UMIST 26 Violet Reactive | 0.24 | 0.18 | 0.15 | 5.70 |

The amount of manganese found on fabrics washed with manganese acetate in homogeneous phase was highest. The level of manganese on fabrics with the catalyst from Example 10 is similar to that delivered by the laundry detergent alone.

### Example 19

### Screening for Deleterious Effect on White Fabrics

The effect on white silk and white viscose fabrics caused by the catalyst from Example 10, sample A, was compared to the damage caused by catalysis in homogenous phase and to that of a standard laundry detergent compact.

Tested products and dosages were as in Example 17.

Ten cumulative washes at 60° C. temperature were conducted using 1 litre solution in a beaker, adding a new/fresh sachet/prototype to each wash.

Instrumental evaluation via spectroscopy according to the Ganz scale was conducted. Results are in the below table:

| | Untreated | 1 | 2 | 3 |
|---|---|---|---|---|
| White Silk | 41.2 | 65.4 | 58.3 | 33.0 |
| White Viscous | 212.9 | 206.9 | 206.4 | 146.2 |

The lower the Ganz number, the worse the whiteness result.

The catalyst from Example 10, sample A, did not cause any visible deleterious effect. The whiteness results delivered by the catalyst from Example 10, sample A, is in line with the detergent alone. Manganese acetate in homogeneous phase caused a visible deleterious effect on white fabrics, making silk and viscose “yellowish”.

### Example 20

### Production of PMMA+Catalyst—Solvent Casting

In a glass beaker, 15 g of PMMA (Aldrich-Sigma, average Mw 120,000) was dissolved in an organic solvent (chloroform, methyl ethyl ketone or acetic acid). The solution was mixed to obtain a high viscous gel. 0.3 g of manganese acetate tetrahydrate (Kemira) was added and mix until a homogeneous dispersion was obtained. The mixture was inserted into a syringe and small drops were expressed. These were dried at 105° C. for 2 hours.

The resulting material comprised porous white spheres with average diameter between 3 mm and 5 mm.

### Example 21

### Catalytic Activity—Saffron Test

Sphere samples from Example 20 were tested for their catalytic activity on the bleaching of saffron (as in Example 2).

0.25 g/litre of the sample (containing about 4400-4480 ppm of Mn) was added to a solution containing saffron, percarbonate and TAED, under agitation. The catalytic activity was measured by spectrophotometer at 430 nm over 30 minutes at 20° C. The results are:

| | | Catalyst | Homogeneous |
|---|---|---|---|
| Time (min) | No Catalyst | Example 20 | Mn Acetate |
| 0 | 100 | 100 | 100 |
| 10 | 96 | 88 | 86 |
| 15 | 85 | 74 | 74 |
| 30 | 60 | 50 | 50 |

The catalyst of Example 20 exhibits catalytic activity on the bleaching of saffron in line with the usage of parity concentration of manganese acetate tetrahydrate in homogeneous phase.

### Example 22

### Multi-Usage Test

In a consecutive test, 0.25 g/L of solid sphere (from example 20), was subjected to 10 consecutive usages (the saffron test from Example 2).

The results are reported in the table below.

| Time | Usage | | | | | | | | | |
|---|---|---|---|---|---|---|---|---|---|---|
| (min) | 1 | 2 | 3 | 4 | 5 | 6 | 7 | 8 | 9 | 10 |
| 0 | 100 | 100 | 100 | 100 | 100 | 100 | 100 | 100 | 100 | 100 |
| 10 | 88 | 87 | 87 | 89 | 89 | 90 | 88 | 84 | 89 | 90 |
| 15 | 74 | 74 | 73 | 76 | 75 | 78 | 76 | 71 | 77 | 76 |
| 30 | 50 | 49 | 48 | 51 | 51 | 53 | 50 | 48 | 51 | 50 |

The results confirm catalytic activity on the bleaching of saffron after even after 10 consecutive usages:

From the first up to tenth usage of the sample the level of catalysis performance on the bleaching of saffron is constant.

### Example 23

### Manganese Release

The amount of manganese was measured from the liquors of example 22 via Atomic Adsorption Spectroscopy (Perkin Elmer Analyst 300).

Results are reported in the following table:

| | ppm Mn |
|---|---|
| 1^{st} usage | 0.041 |
| 2^{nd} usage | 0.025 |
| 3^{rd} usage | 0.017 |
| 4^{th} usage | 0.051 |
| 5^{th} usage | 0.034 |
| 6^{th} usage | 0.014 |
| 7^{th} usage | 0.017 |
| 8^{th} usage | 0.079 |
| 9^{th} usage | 0.015 |
| 10^{th} usage | <0.005 |

The amount of manganese released is insignificant/negligible compared to the total amount of manganese added (amount of Mn metal added in the wash solution is 1.12 ppm).

### Example 24

### Stain Removal Test Results

A performance test was conducted under realistic washing conditions.

The washing test was conducted using standard soils, a compact laundry detergent taken from the market as the base detergent plus 5 g/wash of sphere from Example 20 introduced in a cellulose non-woven sachet.

The washing conditions used tap water at 25° F. hardness, 30° C. washing under a deep cleaning program in a front-loading European washing machine, using 3.5 kg of new and clean cotton ballast, with four replications. Final drying in a tumble drier and ironing of technical swatches. Instrumental evaluation via spectrophotometer (Y value).

The stain removal results are summarized in the following table.

| | | Detergent | Plus |
|---|---|---|---|
| Standard Stains: | | Alone | Catalyst |
| CFT CS-19 Peach Juice | cot | 81.0 | 81.3 |
| Empa 167 Tea | cot | 66.0 | 68.1 |
| Empa 168 Tea | p/c | 67.5 | 69.7 |
| WFK 10K Coffee | cot | 80.8 | 81.1 |
| WFK 10LI Red wine | cot | 74.2 | 75.2 |
| WFK 10Z chocolate | cot | 71.8 | 72.4 |
| CFT CS-19 Blueberry Juice | cot | 72.6 | 73.3 |

(Each value is the average of four measurements)

The sphere sample exhibited catalytic activity under consumer relevant washing conditions.

### Example 25

### Manganese Released in Washing Machine Test

The amount of manganese was measured from the liquors of example 24 via Atomic Adsorption Spectroscopy (Perkin Elmer Analyst 300).

Results are reported in the following table:

| | |
|---|---|
| % Mn released from solid | 7.7% |
| catalyst | |

Data reported are the average of four measurements.

The amount of manganese found in the water collected from main wash is negligible compared to the total amount of manganese added via sphere to each wash. The risk of colour/fabrics damage upon cumulative washes is minimized.

### Example 26

### Catalyst Preparation

1.2 g of polyol (Elastogran) was weighed in a plastic beaker of 200 ml capacity. 30 mg of catalyst Mn-TACTD was added and mixed. 0.8 g of isocyanate (Elastogran) was added and mixed. The polyol/isocyanate mixture was then allowed to polymerise, following which the composition was removed from the plastic beaker.

### Example 27

### Oxidation Catalysis Study

The sample from Example 26 was tested for its catalytic activity on the bleaching of saffron as in Example 2, with the exception of bleach activator which was not added.

The sample from example 26 was added to 270 ml solution containing saffron (0.035 gr/l) and percarbonate at 1.38 gr/L (NO TAED), under agitation. The catalytic activity was measured by spectrophotometer at 430 nm over 30 minutes at 20° C.

The results are:

| Time | No Catalyst | |
|---|---|---|
| (min) | (only PCB) | Catalyst Example 26 |
| 0 | 100 | 100 |
| 4 | 99 | 98 |
| 6 | 98 | 97 |
| 8 | 97 | 96 |
| 10 | 96 | 94 |
| 12 | 95 | 92 |
| 14 | 94 | 90 |
| 16 | 93 | 88 |
| 18 | 92 | 86 |
| 20 | 91 | 84 |
| 22 | 90 | 83 |
| 24 | 89 | 81 |
| 26 | 88 | 79 |
| 28 | 87 | 77.5 |

The catalyst of Example 26 exhibits catalytic activity on the bleaching of saffron.

1. A composition comprising a catalyst admixed with an insoluble support matrix.

2. A composition comprising a bleaching catalyst admixed with an insoluble support matrix.

3. A composition according to claim 2, wherein the bleach catalyst comprises a transition metal compound based upon one or more of manganese, copper, iron, silver, platinum, cobalt, nickel, titanium, vanadium, cerium, lanthanum, zirconium, tungsten, molybdenum, ruthenium.

4. A composition according to claim 3, wherein the bleach catalyst comprises a transition metal compound based upon manganese.

5. A composition according to claim 4, wherein the bleach catalyst comprises a hydrated/anhydrous compound of manganese selected from the group comprising the halide (chloride/bromide), sulphate, sulphide, carbonate, nitrate, oxide, acetate, lactate, acetyl acetonate, cyclohexanebutyrate, phthalocyanine, gluconate, bis(ethylcyclopentadienyl), bis (pentamethylcyclopentadienyl), polyol, sorbitol, iditol, mannitol, xylithol, arabintol, lactose, dulsitol, adonitol, erythritol, inositol, cathecol.

6. A composition according to claim 4, wherein the bleach catalyst comprises:— 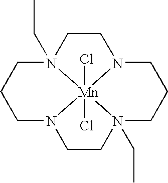
(1,8-diethyl-1,4,8,11-TetraAzaCycloTetraDecane)Manganese (II) chloride.

7. A composition according to claim 4, wherein the bleach catalyst comprises:—

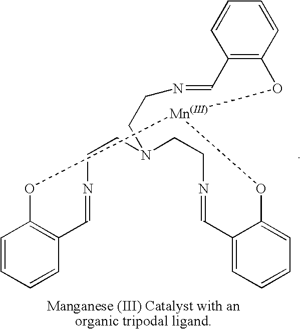

8. A composition according to claim 3, wherein the bleach catalyst comprises: manganese (II) acetate tetrahydrate and/or manganese (II) sulphate monohydrate.

9. A composition according to any one of the preceding claims, wherein the bleach catalyst comprises from 0.0001% to 20%, preferably from 0.001% to 10.00%, preferably from 0.01% to 5.00% more preferably from 0.15% to 2.5% of the composition.

10. A composition according to claim 1, wherein the matrix exhibits porosity.

11. A composition according to claim 1, wherein the support matrix is a shaped article or gadget.

12. A composition according to claim 11, wherein the shaped article is a detergent dosing ball or a part of an automatic washing machine.

13. A composition according to claim 11, wherein the support is at least one of a powder, a particle, a flake, an agglomerate, a sponge, a sheet or a fibre (e.g. a micro-fibre or a nano-fibre).

14. A composition according to claim 13, wherein the support is a particle having a particle diameter in the range of from 10 nm to 10 mm.

15. A composition according to claim 13, wherein the support is a fibre having a diameter in the range of from 30 nm to 2000 μm.

16. A composition according to claim 1, in which the support matrix comprises a polymeric material selected from the group of poly methyl methacrylate, polyurethanes; polyolefins/hydrocarbons; polyvinyl chloride; polyesters, poly vinyl acetate; phenolic resins; copolymers; natural/modified natural polymers; polycarbonates; silicone resins; fluorinated resins.

17. A composition according to claim 1, in which the support matrix comprises one or more of zeolite silica, alumina, zirconia, phosphates (e.g. AlPO₄), ceramic, glass, bauxite, anatase (TiO₂), carbon.

18. A method of producing a catalyst according to claim 1, wherein said method includes one or more processes selected from: thermal treatment, casting, extrusion or electro-.

19. A method of producing the catalyst according to claim 1, wherein said method includes the process step of raising the temperature of a thermoplastic polymer above its glass transition temperature.

20. A method of producing the catalyst according to claim 18, wherein a casting or solvent casting method is used.

21. A method of producing the catalyst according to claim 19, wherein an extrusion method is used.

22. A method of producing the catalyst according to claim 18, wherein an electro-spinning method is used.

23. A detergent composition comprising a catalyst according to claim 1.

24. A detergent comprising a catalyst according to claim 1, which detergent composition further includes: at least one of surfactant (non-ionic, anionic, cationic or amphoteric), builder, bleach, bleach activator, bleach stabilizer, bleaching catalyst, enzyme, polymer, cobuilder, alkalizing agent, acidifying agent, antiredeposition agent, silver protectant, colourant, optical brightener, UV stabilizer, fabric softener, fragrance, soil repellent, anticrease substance, antibacterial substance, colour protectant, discolouration inhibitor, vitamin, phyllosilicate, odor-complexing substance, rinse aid, foam inhibitor, foaming agent, preservative, or auxiliary.

25. In a method of a dishwashing, laundry or hard surface cleaning or hard surface disinfecting or hard surface sanitizing, the method step of providing the catalyst according to claim 1 to the surface being treated in the said method.

26. In a method of treating waste water or a textile or in hair care formulation a hair bleaching formulations, or in a paper pulping process or in a cellulose bleaching method, the method step of providing the catalyst according to claim 1 to the substrate being treated in said method.
